(19) United States
(12) Patent Application Publication
(10) Pub. No.: US 2008/0193616 A1
(43) Pub. Date: Aug. 14, 2008

(54) Beverage compositions comprising polylysine and at least one weak acid

(75) Inventors: Paula Safko, Windemere, FL (US); Shannon Balestrini, Ocoee, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: THE COCA-COLA COMPANY

(21) Appl. No.: 11/705,592

(22) Filed: Feb. 13, 2007

(51) Int. Cl. A23L 2/44; A23L 2/02

(52) U.S. Cl. 426/330.5; 426/330.3

(57) ABSTRACT

The present invention is directed to beverage compositions comprising a preservative system comprising polylysine and at least one weak acid chosen from cinnamic acid, benzoic acid, sorbic acid, alkali metal salts thereof, and mixtures thereof; and at least one beverage component, wherein the beverage composition has a pH ranging from about 1.5 to about 4.5.

The present invention is directed to beverage compositions comprising a preservative system comprising polylysine and at least one weak acid chosen from cinnamic acid, benzoic acid, sorbic acid, alkali metal salts thereof, and mixtures thereof; and at least one beverage component, wherein the beverage composition has a pH ranging from about 1.5 to about 4.5.

Microbial spoilage of beverages remains a well-known concern in the beverage industry today. Beverages have varying degrees of sensitivity to microbiological spoilage depending on intrinsic factors of the beverage such as pH, nutrient content (e.g., juice, vitamin, or micronutrient content), carbonation level, Brix, and water quality (e.g., alkalinity and/or hardness). Spoilage events occur when microorganisms are able to overcome the beverage's intrinsic factors and grow. The microorganisms' ability to overcome these hurdles can be influenced by, among other things, initial contamination level, temperature, and package integrity of the beverage against carbonation loss, i.e., in the case of carbonated soft drinks.

Microbiological spoilage can result from one or more yeasts, bacteria, and/or mold microorganisms. For example, yeasts and bacteria are capable of spoiling carbonated and non-carbonated beverages such as fruit drinks, teas, coffees, enhanced waters, etc. Typically, spoilage by yeasts manifests itself as fermentation with gas and ethanol production, as well as sedimentation. It can also be responsible for off-flavors, odors, and loss of cloud or emulsion stability. Bacteria tend to produce off-flavors, odors, and sedimentation. On the other hand, molds may survive but are generally not capable of growth in low oxygen environments; therefore, they do not spoil carbonated soft drinks except when carbonation is diminished. Mold spoilage of non-carbonated beverages, however, can occur and may be evident after mold mycelial growth by floating globules, clumps, or surface pellicles.

A number of organisms are responsible for spoiling a variety of beverages, including cold-filled beverages. Yeasts such as Saccharomyces, Zygosaccharomyces, Candida, and Dekkera spp. are most common. Also, acidophilic bacteria such as Lactobacillus, Leuconostoc, Gluconobacter, and Zymomonas spp. and molds like Penicillium and Aspergillus spp. can spoil cold-filled beverages.

Other types of beverages are susceptible to spoilage by microorganisms. Spores of acidophilic, thermophilic bacteria, such as Alicyclobacillus spp., and heat resistant mold spores of Byssochlamys and Neosartoria spp. can survive pasteurization and may spoil non-carbonated, hot-filled products such as sport drinks and teas. Also, packaged waters are susceptible to contamination by mold.

Protection against microbiological spoilage of beverages can be achieved using chemical preservatives and/or processing techniques such as hot filling, tunnel pasteurization, ultra-high temperature (UHT), or pasteurization followed by aseptic packaging, and/or pasteurization followed by chilling the beverage. Generally, beverages with a pH<4.6 can be chemically preserved, heat processed, and filled into packages such that the product is not re-contaminated. For example, process techniques such as cold-filling, followed by chemical preservatives or pasteurization with cold-filling, may be used to preserve a cold-filled beverage. In a similar manner, this same beverage may be processed using non-preserved techniques such as hot filling, tunnel pasteurization, pasteurization followed by aseptic filling, or requiring the beverage to be chilled, i.e., under refrigeration following the pasteurization step. Beverages having a pH≧4.6 must be processed such that spores are destroyed using ultra-high temperatures followed by aseptic filling into packages or by using a retort.

Current preservation systems for acidic, shelf-stable, carbonated and non-carbonated soft drinks generally rely on weak acid preservatives (e.g., benzoic and/or sorbic acid). Benzoic and sorbic acids (and salts thereof) effectively inhibit yeasts, bacteria, and molds with some exceptions. Weak acids in beverages exist in equilibrium between their dissociated and undissociated forms, which is dependent upon the dissociation constant of the acid (pKa) and the beverage's pH. The pKa for benzoic acid is 4.19 and the pKa of sorbic acid is 4.76. A beverage pH below the pKa of the involved acid pushes the equilibrium towards the undissociated form. The undissociated form is more efficacious against microorganisms; therefore, weak acid preservatives are most effective in the low pH range.

The preservation properties of weak acids may be enhanced by the addition of preservative enhancers, such as chelating compounds, to the beverage. For example, common chelating compounds added to beverages include calcium disodium ethylenediaminetetraacetic acid (EDTA) or one or more of the polyphosphates such as sodium hexametaphosphate (SHMP). In high nutrient, non-carbonated products, such as those beverages containing juice, vitamins, and/or minerals, the weak acids are more likely to exert inhibition if used in conjunction with preservative enhancers.

As an example, U.S. Pat. No. 5,431,940 teaches about a non-carbonated beverage containing 900 to 3000 ppm of a polyphosphate; 400 to 1000 ppm of a preservative selected from sorbic acid, benzoic acid, alkali metal salts thereof; 0.1% to 10% fruit juice; and 80% to 99.9% water. From that patent, its beverage can be stored at ambient temperature for at least 10 days without substantial microbial proliferation therein after the beverage was exposed to spoilage microorganisms.

Weak acid preservation systems, however, have limitations. Genetic adaptation and subsequent resistance by microorganisms is one of the biggest concerns. See Piper, P. et al., Weak Acid Adaptation: The Stress Response that Confers Yeasts with Resistance to Organic Acid Food Preservatives, 147 Microbiol. 2635-2642 (2001). Certain yeasts such as Z. bailii, Z. bisporus, C. krusei, and S. cerevisiae have specific genes that enable them to resist the weak acid preservatives and grow. This happens despite the presence of preservatives and regardless of the co-presence of EDTA or SHMP. Some bacteria such as Gluconobacter spp. are also thought to be preservative resistant. The levels of weak acids necessary to overcome this resistance have been shown to be far beyond regulatory limits on use levels. Most often, spoilage of preserved teas, juice-containing beverages, and carbonated beverages is due to preservative resistant microorganisms.

Another limitation of weak acid preservation systems is the possibility for creating off-flavors and negative interactions with minerals. For example, weak acids can impart throat or mouth burn when used at high levels. Although there are certain shelf-stable beverages where this attribute may be acceptable, this sensory perception is often considered negative. Similarly, polyphosphates used in weak acid preservation systems can have some limitations. For example, polyphosphates can impart off-flavors to a beverage. Polyphosphates, moreover, can bind to and inactivate minerals such as calcium, iron, and magnesium that may be used to fortify a beverage. Thus, those minerals should be avoided when polyphosphates are part of the preservative system of a beverage. Accordingly, it is desirable to solve at least one of the above-mentioned limitations in the art.

In addition, the other process techniques for low acid beverages (i.e., pH≧4.6) have limitations. Such low acid beverages should be thermally-treated sufficiently to destroy spores of Clostridium botulinum and Bacillus cereus. Examples of such processes include UHT and retort. Even after such processing, the beverage products should be handled in a way to prevent post-processing contamination. Research, however, suggests that there may still be various strains of microorganisms that can survive those different processing techniques. To that end, those processing techniques may not eliminate the potential for spoilage.

The present inventors have discovered that a beverage composition comprising at least one beverage component and a preservative system comprising polylysine and at least one additional weak acid chosen from cinnamic acid, benzoic acid, sorbic acid, alkali metal salts thereof, and mixtures thereof may be useful in solving at least one of the above-mentioned limitations in the art. For example, by replacing polyphosphates, the beverage compositions of the present invention have a reduced level of off-flavors and allow for the addition of nutritional ingredients otherwise negated with polyphosphates, while still maintaining microbial stability. In addition, cinnamic, sorbic, and/or benzoic acid in combination with polylysine may be used at acceptable levels that minimize off-flavors.

In one embodiment, the present invention is directed to a beverage composition comprising: a preservative system comprising from about 0.1 ppm to about 150 ppm of polylysine and from about 10 ppm to about 1000 ppm of at least one weak acid chosen from cinnamic acid, benzoic acid, sorbic acid, alkali metal salts thereof, and mixtures thereof; and at least one beverage component, wherein the beverage composition has a pH ranging from about 1.5 to about 4.5.

In another embodiment, the present invention is directed to a beverage composition comprising: a preservative system comprising from about 0.1 ppm to about 150 ppm of polylysine, from about 10 ppm to about 40 ppm EDTA, and from about 20 ppm to about 1000 ppm of at least one weak acid chosen from cinnamic acid, benzoic acid, sorbic acid, alkali metal salts thereof, and mixtures thereof; and at least one beverage component, wherein the beverage composition has a pH ranging from about 1.5 to about 4.5.

It is to be understood that both the foregoing general description and the following detailed description are exemplary and explanatory only and are not restrictive of the present invention as claimed.

### BRIEF DESCRIPTION OF THE DRAWINGS

FIG. 1 is a graph of values reported in Table 1 of Example 1.

FIG. 2 is a graph of values reported in Table 3 of Example 2.

FIG. 3 is a graph of values reported in Table 5 of Example 3.

FIG. 4 is a graph of values reported in Table 7 of Example 4.

FIG. 5 is a graph of values reported in Table 9 of Example 5.

FIG. 6 is a graph of values reported in Table 10 of Example 5.

FIG. 7 is a graph of values reported in Table 12 of Example 6.

### DESCRIPTION

The present invention is directed to a beverage composition comprising a preservative system comprising polylysine and at least one weak acid chosen from cinnamic acid, benzoic acid, sorbic acid, alkali metal salts thereof, and mixtures thereof; and at least one beverage component, wherein the beverage composition has a pH ranging from about 1.5 to about 4.5. The preservative system comprises antimicrobial amounts of polylysine and at least one weak acid.

The present invention has been surprisingly and unexpectedly discovered to have microbial stability. Microbial stability can be achieved through the combination of the compounds comprising the preservative system, the pH of the composition, the water, and the at least one beverage component. As a result, beverage compositions of the present invention avoid at least one inherent limitation of other preservatives such as off flavors and/or sequestering fortified vitamins or minerals. In addition, the present invention can also avoid the use of certain processing techniques such as aseptic-filling, hot-filling, pasteurization with cold-filling, or tunnel pasteurization to maintain microbial stability.

As used herein, “microbial stability” or “microbiological stability” refers to at least a 2.0 log CFU/ml reduction in microorganisms, such as yeasts and/or bacteria, within 14-28 days in comparison to an unpreserved beverage (control). The inoculation level is 1×10⁴ CFU/ml of bacteria or yeasts. With regard to mold, expression is evaluated at around 4 weeks (30 days) to determine the presence or absence of expression, after the beverage was inoculated with mold at a level of 1×10⁴ CFU/ml.

As used herein, the term “beverage” or “beverage composition” refers to a liquid drink that is appropriate for human or animal consumption. Mention may be made of beverages, but not limited to: energy drinks, flavored water, fruit smoothies, sport drinks, fruit juices (e.g., juice drinks and 100% fruit juice as provided in 21 C.F.R. Part 101.30), carbonated sodas/juices, shakes, protein drinks (e.g., dairy, soy, rice or other), meal replacements, drinkable dairy yogurts, drinkable soy yogurts, coffees, cola drinks, fortified waters, low acid beverages as defined in 21 C.F.R. Part 113, acidified beverages as defined in 21 C.F.R. Part 114, syrups, cordials, dilutables such as squashes, health drinks, functional beverages (e.g., nutraceuticals), nectars, tonics, horchata (i.e., vegetable and/or rice components made into a beverage), frozen carbonated beverages, frozen uncarbonated beverages, and tea beverages prepared from tea concentrate, extracts, or powders.

Preservative System

According to the present invention, the preservative system comprises polylysine and at least one weak acid chosen from cinnamic acid, benzoic acid, sorbic acid, alkali metal salts thereof, and mixtures thereof. For example, the preservative system comprises from about 0.1 ppm to about 150 ppm of polylysine and at least one weak acid chosen from cinnamic acid, benzoic acid, sorbic acid, alkali metal salts thereof, and mixtures thereof.

Each of the components of the preservative system are known to be preservatives individually, as is the mechanism by which each preservative inhibits microbial growth. The present inventors, however, discovered that those particular preservatives, in combination with the levels of those preservatives and other parameters, can achieve and maintain microbial stability without affecting the flavor of the beverage to yield a beverage microbially stable at ambient temperature. For example, each of the preservatives, and/or at least one of the preservatives used in the preservative system, can be used in an amount less than it would be needed if used alone as a preservative in a beverage.

Polylysine demonstrates a wide antimicrobial spectrum and can be incorporated into beverages as a preservative and/or food additive based on this antimicrobial activity. Although the mechanism of action for polylysine is unknown, some postulate that, based on the compound's cationic properties, it influences the cell surface of microorganisms. Large quantities of polylysine produce high antimicrobial activity but also create a bitter taste in the beverage. In contrast, low concentrations of polylysine can be used, while still maintaining antimicrobial activity, to avoid off-flavors.

As used herein, the term “polylysine” refers to ε-polylysine—a homopolymer of about 25 to 35 L-lysine units, a common component of protein—which can be produced naturally or synthetically. Natural production of ε-polylysine can be produced by Streptomyces albulus. E-polylysine contains an amide linkage between the ε-amino and carboxyl group. E-polylysine may be in combination with, for example, water or other acceptable ingestible components such as salt, lactose, vinegar, dextrin, and/or sodium acetate.

According to the present invention, polylysine is present in an amount ranging from about 0.1 ppm to about 150 ppm, such as from about 0.75 ppm to about 20 ppm, and further, for example, from about 0.75 ppm to about 10 ppm such as about 0.75 ppm to about 2 ppm. In at least one embodiment, polylysine is present in an amount of about 0.75 ppm. In yet a further embodiment, polylysine is present in an amount of about 10 ppm.

In addition to the polylysine component of the preservative system, at least one weak acid chosen from cinnamic acid, benzoic acid, sorbic acid, alkali metal salts thereof—such as potassium, calcium, and sodium salts—and mixtures thereof is also included. Weak acids such as cinnamic, benzoic, and/or sorbic acid are known as food additives and antimicrobial agents. Because polylysine and at least one weak acid are used in combination, levels of each of these preservatives (polylysine or at least one weak acid) may vary based on the level of the other preservative component (polylysine or at least one weak acid).

The at least one weak acid (naturally or synthetically produced) may be present in the composition of the present invention in an amount ranging from about 10 ppm to about 1000 ppm, depending on whether a weak acid is used alone or in combination. For example, when cinnamic, benzoic, and sorbic acid are used in combination they may be present in the beverage in an amount ranging from about 10 ppm to about 500 ppm, such as from about 100 ppm to about 500 ppm, and further, for example, from about 150 ppm to about 350 ppm. Alternatively, when the at least one weak acid is cinnamic, benzoic, or sorbic acid alone, the weak acid may be present in the beverage in an amount ranging from about 10 ppm to about 500 ppm. In at least one embodiment, the at least one weak acid is sorbic acid or a salt thereof in an amount ranging from about 150 ppm to about 350 ppm.

Beverage Component

The beverage composition of the present invention comprises at least one beverage component. For example, the at least one beverage component may be, but not limited to, at least one juice, at least one sweetener, and/or mixtures thereof. That beverage component serves as the food source for microorganism and can be any ingredient added to the beverage composition that can nourish microorganisms (e.g., yeasts, bacteria, and/or molds) which leads to spoilage.

For example, the at least one juice and/or sweetener can provide to the composition of the present invention beneficial characteristics such as flavor and nutrients. Although the at least one juice and/or sweetener can impart beneficial properties to the compositions, each also can be a food source for microorganisms that have infiltrated the composition. As a result, and without surrendering microbial stability, the use of the present invention provides for the incorporation of the at least one beverage component such as at least one juice, at least one sweetener, and/or mixtures thereof.

The at least one juice component may be derived from, but not limited to, citrus and non-citrus fruits, vegetables, botanicals, or mixtures thereof. Mention may be made, among citrus and non-citrus fruits, but not limited to: peaches, nectarines, pears, quinces, cherries, apricots, apples, plums, figs, kiwis, clementines, kumquats, minneolas, mandarins, oranges, satsumas, tangerines, tangelos, lemons, limes, grapefruits, bananas, avocados, dates, hogplums, mangos, gooseberry, star fruits, persimmons, guavas, passion fruits, papayas, pomegranates, prickly pears, blue berries, black berries, raspberries, grapes, elderberries, cantaloupes, pineapples, watermelons, currants, strawberries, cranberries, acai berries, and mixtures thereof.

Mention may be made among vegetables and/or herbs, but not limited to: carrots, tomatoes, spinach, peppers, cabbage, sprouts, broccoli, potatoes, celery, anise, cucumbers, parsley, beets, wheat grass, asparagus, zucchini, rhubarb, turnip, rutabaga, parsnip, radish, fennel, basil, rosemary, thyme, and mixtures thereof.

Botanical juices can be used and are often obtained from, for example, but not limited to: beans, nuts, bark, leaves, and roots of a plant, i.e., something other than the fruit of the plant. For example, botanical juices may impart flavors such as vanilla, coffee, cola, coca, tea solids (e.g., tea concentrates, extract or powders), and mixtures thereof. These flavors may be derived naturally or synthetically.

The at least one juice may be present in the beverage composition of the present invention in an amount ranging from 0.1% to about 100% by volume relative to the total composition. For example, the at least one juice may be present in an amount ranging from about 0.1% to about 25%, and further, for example, from about 1% to about 10% by volume relative to the total composition.

The at least one sweetener may be chosen from nutritive sweeteners, non-nutritive sweeteners, and/or mixtures thereof. Of the nutritive (i.e., caloric) sweeteners, the present compositions may include, for example, carbohydrate sweeteners such as monosaccharides and/or disaccharides. Mention may be made among nutritive sweeteners, but not limited to: fructose, sucrose, glucose, sugar alcohols, corn syrup, evaporated cane juice, rice syrups, maple syrup, black malt syrups, fruit juice concentrate, honey, agave, tapioca syrup, chicory root syrup, and mixtures thereof. The non-nutritive sweeteners may include, but not limited to: luo han guo (may be in the form of a juice and may contribute a minute amount of calories), stevia and derivatives thereof, erythrithol, acesulfame potassium, aspartame, neotame, saccharin, sucralose, tagatose, alitame, cyclamate, and mixtures thereof. Blends of nutritive as well as non-nutritive sweeteners are contemplated herein. The at least one sweetener may be present in an amount conventionally used in beverage compositions and may be adjusted depending upon the desired beverage composition.

pH

The compositions of the present invention, e.g., beverages, may have a pH ranging from about 1.5 to about 4.5. It is known in the art that the pH of a beverage may be a factor in maintaining a shelf-stable beverage, as the growth of some microorganisms may be hindered under acidic conditions. This, however, is not the case for acidophilic microorganisms such as Saccharomyces and Candida which thrive in such an acidic environment. Utilizing the present invention allows the composition to maintain microbial stability even in view of these acidophilic microorganisms.

In addition, compositions of the present invention may comprise fruits and vegetables resulting in a high acid beverage containing tart flavors. Generally, a beverage having at least one carbohydrate in the amount ranging from 0.1% to 15% by weight relative to the total composition, and at least one acid ranging from 0.01% to 0.7% by weight relative to the total composition, can offset such acid levels and tart flavors. This range is suitable for beverages and possibly syrups as well, when the syrup is properly diluted to form a single strength beverage.

For an acidic beverage (pH<4.6), the acidity of the beverage can be adjusted to and maintained within the recited range by known and conventional methods in the art. For example, the pH can be adjusted using one or more acidulants. In addition, the use of acidulants may assist in microbial inhibition at the same time as maintaining the pH of the beverage. Compositions of the present invention, however, may inherently have a desirable pH without the use of any acidulants or other components to modify the pH. Thus, the incorporation of at least one acidulant is optional in compositions of the present invention.

Mention may be made among possible acidulants, but not limited to, organic and inorganic acids to be used in adjusting the pH of a composition of the present invention such as a beverage. The acidulants may also be in an undissociated form or in their respective salt form such as potassium, sodium, or hydrochloride salts. Acidulants used in the present composition may be, but not limited to: citric acid, ascorbic acid, malic acid, benzoic acid, phosphoric acid, acetic acid, adipic acid, fumaric acid, gluconic acid, tartaric acid, lactic acid, propionic acid, sorbic acid, or mixtures thereof. In one embodiment, the acidulant is citric acid.

Moreover, the amounts of the acidulant(s), which may be present in the composition according to the present disclosure, are those conventionally used in beverage compositions. For example, at least one acidulant may be present in an amount ranging from about 0.01% to about 1% by weight relative to the composition.

Optional Components

Compositions of the present invention may further comprise optional components commonly found in conventional beverages. Such optional ingredients may be dispersed, solubilized, or otherwise mixed into or with the composition of the present invention. For example, mention may be made of conventional beverage components, but not limited to: water, ethylenediaminetetraacetic acid (EDTA), additional preservatives, coloring agents, flavoring agents, flavonoids, vitamins, minerals, proteins, emulsifiers, carbonation components, thickeners (i.e., viscosity modifiers and bodying agents), antioxidants, anti-foaming agents, and mixtures thereof.

Water

According to the present invention, the beverage composition further comprises water. The water may be “treated water”, “purified water”, “demineralized water”, and/or “distilled water.” The water should be suitable for human or animal consumption and the beverage composition should not be affected by the inclusion of the water. This added water to the composition is in addition to water found in or with other components of the present invention, e.g., the at least one juice component.

The water of the present invention may be present in an amount ranging from about 60% to about 99%, and further, for example, from about 80% to about 99% by volume relative to the total composition. The added water component may also meet certain quality standards such as biological, nutrient, and sediment criteria.

The water hardness of the added water component may range from about 55 ppm to about 250 ppm, such as from about 60 ppm to about 180 ppm. Water hardness refers to the amount of cations, e.g., calcium carbonate, present in the water. As provided in the present invention, water hardness is measured according to the Association of Official Analytical Chemists (AOAC) standards described in the Official Methods of Analysis, published by the AOAC (William Horwitz ed., 18th ed. 2005), the relevant contents of which are incorporated herein by reference.

EDTA

The preservative system may also comprise ethylenediaminetetraacetic acid (EDTA). As used herein, “EDTA” refers to natural and synthetically produced EDTA and salts thereof such as calcium disodium ethylenediaminetetraacetic acid or Ethylenediaminetetraacetic acid disodium salt. EDTA is a chelating agent that is approved by the FDA as being generally recognized as safe (GRAS) and can be used as a food additive. See 21 C.F.R. §§ 172.0135, 173.315. Because of the chemical structure, EDTA can, among other things, sequester metals and stabilize vitamins. It is postulated that by chelating metals, EDTA removes these metals that are needed by microorganisms and essentially starves the microorganisms.

EDTA may be present in the composition of the present invention in an amount ranging from about 10 ppm to about 40 ppm, such as from about 10 ppm to about 30 ppm, and further, for example, from about 15 ppm to about 25 ppm. In at least one embodiment, EDTA is present in the beverage composition in an amount ranging from about 15 ppm to about 30 ppm.

Additional Preservatives

The composition of the present invention may further comprise at least one additional preservative in addition to the preservative system. As used herein, the term “preservative” includes all preservatives approved for use in beverage and/or food product compositions. Mention may be made among additional preservatives such as, but not limited to: chemical preservatives (e.g., citrates, and salts thereof); free fatty acids; esters and derivatives thereof; peptides; lauric arginate; cultured dextrose; neem oil; eugenol; p-cymene; thymol; carvacrol; linalool; natamycin; tea tree oil; fingerroot extract; acai powder; 4-hydroxybenzyl isothiocyanate and/or white mustard seed essential oil; and other weak acids such as cinnamic acid and/or mixtures thereof. Additional preservatives, moreover, may include, but not limited to: lacto-antimicrobials such as lactoferrin, lactoperoxidase, lactoglobulins and lactolipids; ovo-antimicrobials such as lysozyme, ovotransferrin, ovoglobulin IgY and avidin; phyto-antimicrobials such as phyto-phenols, flavonoids, thiosulfinates, catechines, glucosinolates and agar; bacto-antimicrobials such as probiotics, nisin, pediocin, reuterin and sakacins; acid-anticmicrobials such as lactic acid, acetic acid and citric acid; milieu-antimicrobials such as sodium chloride; polyphosphates; chloro-cides; and ozone. The at least one additional preservative may be present in an amount not exceeding maximum mandated levels as established by the U.S. Food and Drug Administration or other food and beverage governing bodies.

Coloring Agents

The compositions of the present invention may further comprise at least one coloring agent. Mention may be made among colorants, such as, but not limited to, FD&C dyes, FD&C lakes, and mixtures thereof. Any other colorant used in beverages and/or food products may be used. For example, a mixture of FD&C dyes or a FD&C lake dye in combination with other conventional beverage and/or food colorants may be used. Moreover, other natural coloring agents may be utilized including, for example, fruit, vegetable, plant extracts, and/or other extracts, such as grape, black currant, carrot, beetroot, red cabbage, hibiscus, cochineal, tumeric, carotene, annatto, and/or any combination thereof.

Flavoring Agents

The present composition may further comprise at least one flavoring agent. The at least one flavoring agent may include, but not limited to, oils, extracts, oleoresins, any other flavoring agent known in the art, and mixtures thereof. For example, suitable flavors include but are not limited to: fruit flavors, cola flavors, coffee flavors, tea solids (e.g., tea concentrates, extracts or powders), chocolate flavors, dairy flavors, coffee, kola nut, ginseng, cacao pod, and mixtures thereof. Suitable oils and extracts may include, but are not limited to, vanilla extract, citrus oil and extract, and mixtures thereof. These flavors may be derived from natural sources such as juices, essential oils, and extracts, or they may be synthetically produced. Moreover, the at least one flavoring agent may be a blend of various flavors such as fruits and/or vegetables.

Flavonoids

The present invention may optionally comprise at least one flavonoid, which is a natural compound from a class of water-soluble plant pigments. Flavonoids are known to have antioxidant, anti-microbial, and anti-cancer activity. Flavonoids may be found in plants, vegetables, fruits, flowers or any other known natural source by a skilled artisan. Flavonoids may be derived from these sources by conventional means known in the art. Derivation is not limited to a single source of flavonoids, but may also include mixture of sources such as extraction from a single vegetable or mixture of vegetables. In addition, flavonoids may be produced synthetically or by another appropriate chemical means and incorporated into the present beverage composition. Mention may be made of flavonoids such as, but not limited to: quercetin, kaempferol, myricetin, isohammetin, catechin, and derivatives or mixtures thereof.

Vitamins and Minerals

According to the present invention, at least one supplemental vitamin and/or mineral may be optionally incorporated into beverage compositions of the present invention. Similar to the at least one juice component, the added vitamin(s) and/or mineral(s) can also serve as a food source for the microorganisms. Historically, vitamins and minerals such as calcium, iron, and magnesium could not be fortified into a beverage composition because preservatives such as polyphosphates would bind to and inactivate the vitamin and/or mineral. This may be avoided with the beverage compositions of the present invention.

Mention may be made among vitamins, but not limited to; riboflavin, niacin, pantothenic acid, pyridoxine, cobalamins, choline bitartate, niacinamide, thiamin, folic acid, d-calcium pantothenate, biotin, vitamin A, vitamin C, one or more B-complex vitamins vitamin D, vitamin E acetate, vitamin K, and derivatives or mixtures thereof. Mention may be made among minerals such as, but not limited to: calcium, zinc, iron, magnesium, manganese, copper, iodine, fluoride, selenium, and mixtures thereof. Synthetic vitamins and minerals are also contemplated within the scope of compositions of the present invention. The addition of optional vitamins and minerals should be done with such care that the flavor of the present composition may not be significantly affected. The at least one supplemental vitamin and/or mineral may also be added to assist the consumer in meeting the U.S. Recommended Daily Intake (RDI) for vitamins and minerals.

Protein

In addition, compositions of the present invention may further comprise at least one protein component, e.g., soy protein extract. The at least one protein component may be from, for example, but not limited to: milk proteins such as casein (caseinate), whey protein, egg whites, gelatin, collagen, and mixtures thereof.

Emulsifier

The present invention optionally comprises at least one emulsifier. Any beverage and/or food grade emulsifier can be used to stabilize an emulsion. Mention may be made of emulsifiers, but not limited to: gum acacia, modified food starches (e.g., alkenylsuccinate modified food starches), anionic polymers derived from cellulose (e.g., carboxymethylcellulose), gum ghatti, modified gum ghatti, xanthan gum, glycerol ester of wood rosin (ester gum), tragacanth gum, guar gum, locust bean gum, pectin, lecithin, and mixtures thereof. For example, a beverage can comprise a cloud emulsion or a flavor emulsion.

For cloud emulsions, the clouding agent can comprise at least one fat or oil stabilized as an oil-in-water emulsion using a suitable food grade emulsifier. Any of a variety of fats or oils may be employed as the clouding agent, provided that the fat or oil is suitable for use in compositions such as beverages. Any suitable beverage and/or food grade emulsifier can be used that can stabilize the fat or oil clouding agent as an oil-in-water emulsion.

Flavor emulsions useful in the beverage compositions of the present invention comprise at least one suitable flavor oil, extract, oleoresin, essential oil, and/or the like, which are known in the art for use as flavorants in beverages.

Carbonation

According to the present invention, carbonation (e.g., carbon dioxide) may be further added based on techniques commonly known to a person of ordinary skill in the art. For example, carbon dioxide may be added to the water introduced into the beverage or beverage concentrate. The amount of carbonation introduced into the compositions of the present invention will depend on the nature of the beverage and the desired level of carbonation.

Thickeners

Compositions of the present invention may optionally comprise at least one thickener. Mention may be made of thickeners, i.e., viscosity modifiers and/or bodying agents, such as, but not limited to: cellulose compounds, gum ghatti, modified gum ghatti, guar gum, tragacanth gum, gum arabic, pectin, xanthum gum, carrageenan, locust bean gum, pectin, lecithin, and mixtures thereof.

Antioxidants

Compositions of the present invention may further comprise at least one antioxidant. The at least one antioxidant may include, but not limited to: ascorbic acid; vitamin E; guar gum; propylgalacte, sulfite and metabisulfite salts; thiodiproprionic acid and esters thereof; spice extracts; grape seed; tea extracts; and mixtures thereof.

Amino Acids

According to the present invention, compositions of the present invention may further comprise at least one amino acid. The at least one amino acid may include, but not limited to: alanine, arginine, asparagine, cysteine, glutamine, glycine, histidine, leucine, methionine, ornithine, proline, phenylalanine, serine, threonine, tryptophan, tyrosine, valine, and mixtures thereof.

Anti-Foaming Agents

The present invention may further comprise at least one anti-foaming agent. The at least one anti-foaming agent may include, but not limited to: calcium alginate; silicone polymers such as polydimethylsiloxane; fatty acid esters such as propylene glycol fatty acid esters; glycerin fatty acids esters; sorbitan fatty acid esters; and mixtures thereof.

The amounts of these above optional components, which may be present in the compositions according to the invention, are those conventionally used in beverage compositions. In addition, the amount of these additional components will depend upon the desired beverage compositions.

Preparation

The beverage compositions according to the present invention can be made according to methods which are well known by skilled artisans in the beverage industry. For example, the beverage composition can be prepared by dispersing, dissolving, diffusing, or otherwise mixing all the ingredients simultaneously together with the addition of water if needed. Also, preparation can be performed by sequentially adding ingredients based on solubility or any other parameters with the addition of water where appropriate. This may be done with a mechanical stirrer or by homogenization techniques commonly known in the art. In addition, the composition of the present invention may be made into a liquid or dry beverage concentrate.

Microbial Evaluation

The compositions of the present invention may be evaluated to determine the microbial stability based on techniques known to those of ordinary skill in the art. For example, one way to determine microbial stability is by inoculating a beverage, or beverage matrix of the present invention, with a group of microorganisms such as molds, yeasts, and bacteria and evaluating the beverage for microbial stability. These microorganisms may be those previously identified in spoiled beverage incidents such as those mentioned below under the Examples or any other type of yeast, mold, bacteria, and/or mixtures thereof. Once the beverage or beverage matrix is inoculated, periodic plate counts can be preformed to determine growth of the microorganisms. Based on the plate counts, one can determine the degree of microorganism growth in the inoculate composition, e.g., beverage. The present inventors used standard methods of enumeration in food and beverage microbiology, for example, such as those described in Ito & Pouch-Downes, Compendium of Methods for the Microbiological Examination of Foods (4th ed. Amer. Pub. Health Assoc. 2001), and those found in Notermans, et al., A User's Guide to Microbiological Challenge Testing for Ensuring the Safety and Stability of Food products, 10 Food Microbiology 145-57 (1993), the contents of which are incorporated herein by reference.

In addition, flow cytometry may also be used for growth determinations of the microorganisms. See Jay, J. M., Modern Food Microbiology (Aspen Publishers, Inc., 2000). Flow cytometry uses the principles of light scattering, light excitation and emission of fluorochrome molecules to identify and count the microorganisms. For example, a sample of the inoculated composition is injected into the center of a sheath flow. As the microorganisms intercept the light source, they scatter the light and fluorochromes are excited to a higher energy state. The higher energy state releases as photons of light having specific properties. The light is essentially converted into electrical pulses that are then transmitted into a readable format such as a graph of viable cell count.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present disclosure. At the very least, within the claims, each numerical parameter should be construed in light of the number of significant digits and ordinary rounding approaches.

Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements.

### EXAMPLES

The following examples include embodiments of beverage compositions according to the present invention. Those compositions were prepared and evaluated to determine microbial stability, i.e., the inhibition and/or reduction of microbial growth and/or microorganism death when inoculated with various microorganisms.

The following examples are considered to embody the present invention and in no way should be interpreted as limitations upon the present invention.

In order to examine beverage compositions falling within the present invention for their microbial stability, the following organisms were used to prepare the various yeast, bacteria, and mold inoculum:

| Microorganism Type | Strain |
|---|---|
| Yeast | Saccharomyces spp. |
| | Zygosaccharomyces spp. |
| | Candida spp. |
| Bacteria | Lactobacillus spp. |
| | Leuconostoc spp. |
| | Acetobacter spp. |
| Mold | Byssochlamys spp. |
| | Pennicilium spp. |
| | Paecilomyces spp. |

The examples described below used at least one, and in some cases three or more, of the above-mentioned microorganisms to prepare a cocktail for testing. The inoculum for each type of microorganism was prepared as follows:

Yeast and Bacterial Inoculum:

A composite culture was prepared of microorganisms by placing one loop full of each microorganism type into sterile inoculum medium. The medium was incubated at room temperature for about 72 hours to enable the growth of the microorganisms. The microorganism were plated and counted for CFU/ml levels. A healthy yeast or bacterial culture may contain about 1×10⁷ CFU/ml.

In the results reported below for the bacteria and yeasts, a value of 0.5 represents an undetectable level of microorganisms.

Mold Inoculum:

Orange Serum Agar Petri dishes were spot inoculated with each type of mold. The plates were incubated for approximately two weeks. The spores were washed off the plates and re-suspended in phosphate buffer. The spore population was counted by surface plating on Orange Serum Agar. The plates were incubated at 27° C. for approximately 3 to 5 days.

The results reposted below for mold are based on an expression value versus a plated count. Thus, the higher the expression value, the more growth in the inoculated matrix. For example, an expression value of three represents the largest amount of growth, whereas an expression value of zero represents no growth,

### Example 1

A non-carbonated beverage matrix was formulated. The non-carbonated beverage formulation and processing details are provided below.

A non-carbonated beverage matrix was prepared that included:

| Ingredients | Amount |
|---|---|
| Flavoring | 0.114% (v/v) |
| Colorant | 0.005% (v/v) |
| Sweetener | 10.9% (v/v) |
| Cloudifier | 0.0016% (v/v) |
| Water | qs |

The following preservative systems were examined with the beverage matrix above:

| | Sorbic | | | | | | |
|---|---|---|---|---|---|---|---|
| Beverage | Acid | Polylysine | % RDI | % | | | % |
| Composition | (ppm) | (ppm) | Calcium | Juice | pH | °Brix | Acid |
| Control | 0 | 0 | 0 | 3 | 3.17 | 11.89 | 0.28 |
| A | 200 | 0.75 | 0 | 3 | 3.17 | 11.89 | 0.28 |
| B | 200 | 0.75 | 0 | 5 | 3.33 | 11.76 | 0.29 |
| C | 250 | 0.75 | 0 | 10 | 3.51 | 11.81 | 0.31 |
| D | 350 | 1.5 | 10 | 10 | 4.33 | 12.14 | 0.31 |
| E | 350 | 2 | 0 | 10 | 3.51 | 11.81 | 0.31 |

The beverage matrix was blended. It was then split to incorporate the designated preservative system, i.e., Control and A through E, and pasteurized at 97° C. for approximately 20 seconds before being cooled to room temperature. The beverage matrix was filled into sterile bottles and capped, i.e., about 25° C. The beverage matrix was stored at about 4° C. until use. Next, cultures of microorganisms were prepared according to the protocols listed above. Unpreserved and preserved bottles of beverage matrix were inoculated with microorganisms (duplicate bottles per strain were prepared), i.e., 1×10⁴ CFU/ml of yeasts, bacteria, and molds. The bottles were shaken approximately 25 times. An initial sample was removed from each container to represent 0 time. The microorganisms were incubated in the inoculated bottles at 27° C. At the designated time intervals, samples were surface plated from each container, with the bottles being shaken just prior to sampling.

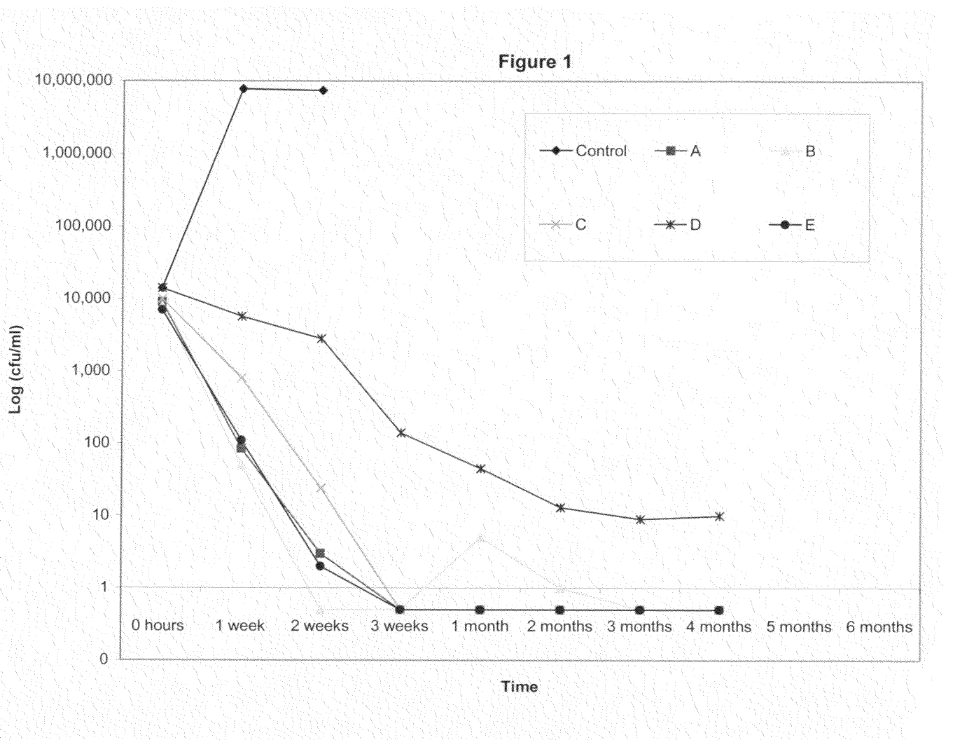

Tables 1 through 3 summarize the results and the beverage compositions examined. FIG. 1 graphically illustrates the results in Table 1.

TABLE 1
Examination of yeasts (mean CFU/ml) in beverage compositions at 27° C.

| | Beverage Composition | | | | | |
|---|---|---|---|---|---|---|
| Time | Control | A | B | C | D | E |
| 0 hours | 14,000 | 9,000 | 8,000 | 10,000 | 14,000 | 7,000 |
| 1 week | 7,800,000 | 85 | 50 | 800 | 5,700 | 110 |
| 2 weeks | 7,400,000 | 3.0 | 0.5 | 24.0 | 2,800 | 2.0 |
| 3 weeks | — | 0.5 | 0.5 | 0.5 | 140 | 0.5 |
| 1 month | — | 0.5 | 5.0 | 0.5 | 45 | 0.5 |
| 2 months | — | 0.5 | 1.0 | 0.5 | 13 | 0.5 |
| 3 months | — | 0.5 | 0.5 | 0.5 | 9.0 | 0.5 |
| 4 months | — | 0.5 | 0.5 | 0.5 | 10.0 | 0.5 |

TABLE 2
Examination of mold in beverage compositions at 27° C. Mold
results are shown in duplicate as Mold 1 and Mold 2.

| Beverage Composition | Mold 1 | Mold 2 |
|---|---|---|
| Control | 3 | 3 |
| A | 0 | 0 |
| B | 0 | 0 |
| C | 0 | 0 |
| D | 0 | 0 |
| E | 0 | 0 |

From data in Tables 1 and 2, a beverage composition of the present invention exhibits microbial stability within 14-28 days of being inoculated with yeasts in comparison with an unpreserved beverage (control). The invention also exhibits no expression of mold when compared to the unpreserved beverage (control). In addition, microbial stability was also achieved in a beverage composition of the present invention containing 10% of the U.S. daily value of calcium.

### Example 2

A non-carbonated beverage matrix was prepared and evaluated as detailed in Example 1 but with the following preservative systems:

| | Sorbic | | | | | | |
|---|---|---|---|---|---|---|---|
| Beverage | Acid | Polylysine | % RDI | % | | | % |
| Composition | (ppm) | (ppm) | Ca | Juice | pH | °Brix | Acid |
| Control | 0 | 0 | 0 | 3 | 2.74 | 11.80 | 0.30 |
| A | 200 | 0.75 | 0 | 3 | 2.74 | 11.70 | 0.30 |
| B | 200 | 0.75 | 0 | 5 | 2.94 | 11.88 | 0.29 |
| C | 250 | 0.75 | 0 | 10 | 3.05 | 11.84 | 0.29 |
| D | 350 | 1.5 | 10 | 10 | 3.68 | 12.13 | 0.29 |
| E | 350 | 2 | 0 | 10 | 3.05 | 11.84 | 0.29 |

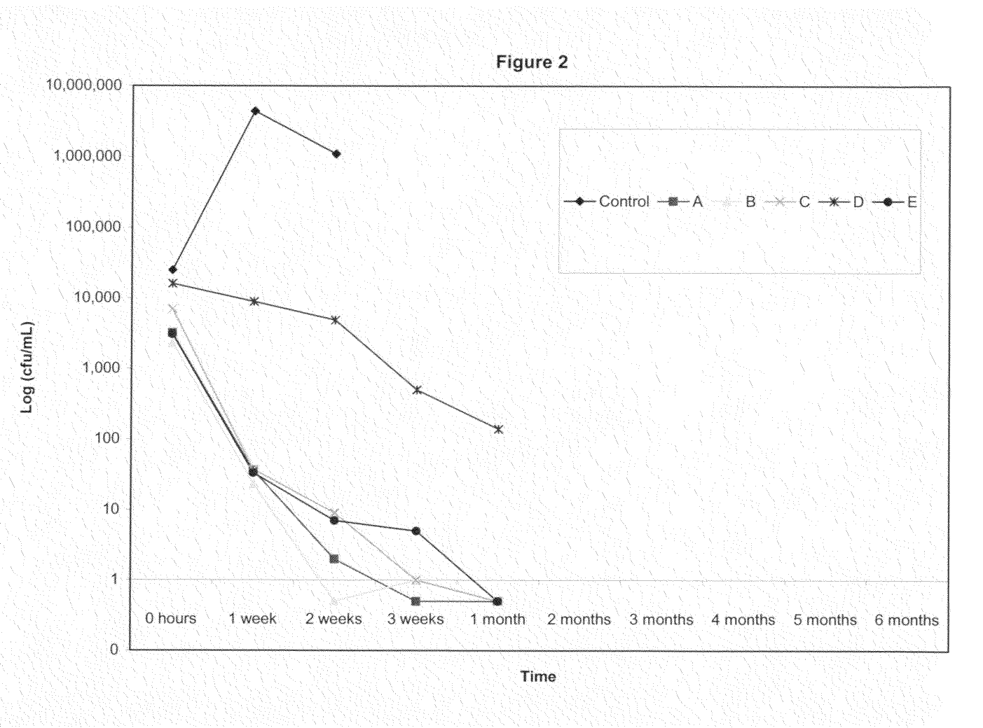

Tables 3 and 4 summarize the results of the experiments. FIG. 2 graphically illustrates the results found in Table 3.

TABLE 3
Examination of bacteria (mean CFU/ml) in beverage compositions
at 27° C.

| | Beverage Composition | | | | | |
|---|---|---|---|---|---|---|
| Time | Control | A | B | C | D | E |
| 0 hours | 25,000 | 3,200 | 2,300 | 7,000 | 16,000 | 3,100 |
| 1 week | 4,400,000 | 36 | 23 | 37 | 8,900 | 33 |
| 2 weeks | 1,100,000 | 2.0 | 0.5 | 9.0 | 4,900 | 7.0 |
| 3 weeks | — | 0.5 | 1.0 | 1.0 | 500 | 5.0 |
| 1 month | — | 0.5 | 0.5 | 0.5 | 140 | 0.5 |

TABLE 4
Examination of mold in beverage compositions at 27° C. Mold
results are shown in duplicate as Mold 1 and Mold 2.

| Beverage Composition | Mold 1 | Mold 2 |
|---|---|---|
| Control | 3 | 3 |
| A | 0 | 0 |
| B | 0 | 0 |
| C | 0 | 0 |
| D | 0 | 0 |

From data in Tables 3 and 4, the present invention demonstrates preservation, i.e., microbial stability, of beverage compositions with juice percentages ranging from 3%, 5%, and 10%.

### Example 3

A non-carbonated beverage matrix was prepared and evaluated as detailed in Example 1 but with the following preservative systems:

| | Sorbic | | | | | | | |
|---|---|---|---|---|---|---|---|---|
| Beverage | Acid | Polylysine | Polylysine | | | | | % |
| Composition | (ppm) | (ppm) | Source | EDTA | % Juice | pH | °Brix | Acid |
| Control | 0 | 0 | None | 0 | 3 | 3.20 | 11.88 | 0.29 |
| A | 200 | 0.75 | Dry | 30 | 3 | 3.20 | 11.88 | 0.29 |
| B | 200 | 0.75 | Solution | 30 | 3 | 3.20 | 11.88 | 0.29 |
| C | 350 | 0.75 | Solution | 30 | 10 | 3.33 | 11.81 | 0.29 |
| D | 350 | 0.88 | Solution | 30 | 10 | 3.33 | 11.81 | 0.29 |
| E | 400 | 0.75 | Solution | 30 | 10 | 3.33 | 11.81 | 0.29 |

In addition, two different forms of polylysine were used to create the beverage compositions, which are identified under the header “Polylysine Source” in the above table. The designated “dry” form comprised polylysine at 1.5% (w/w) in combination with sodium acetate, dextrin, DL-malic acid, sodium citrate, and lactose. The designated “solution” form comprised polylysine at 25% (w/w) along with distilled water.

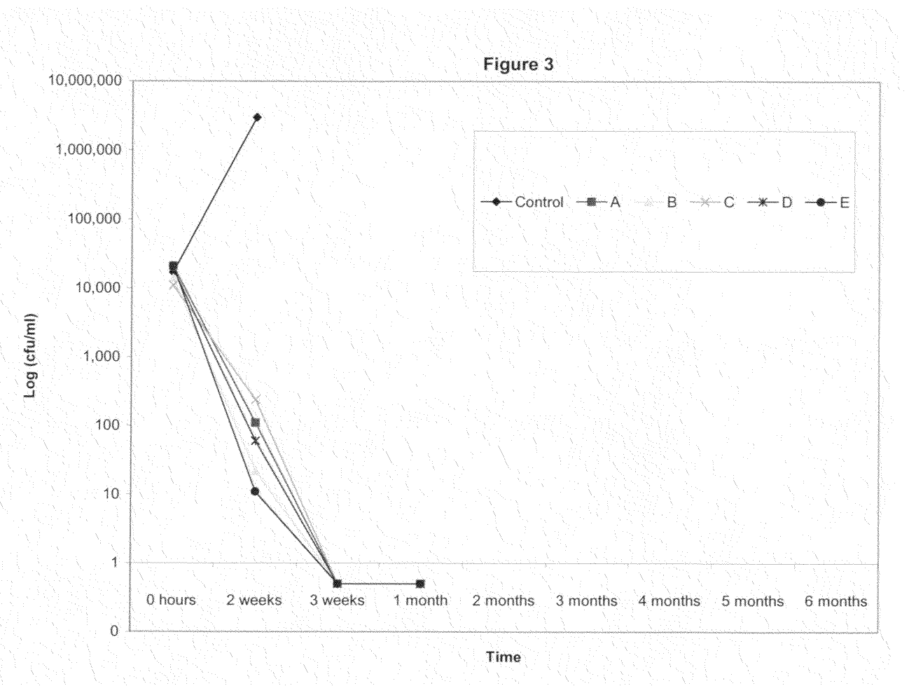

Tables 5 and 6 summarize the results of the experiments. FIG. 3 graphically illustrates the results found in Table 5.

TABLE 5
Examination of yeasts (mean CFU/ml) in a beverage composition at 27° C.

| | Beverage Composition | | | | | |
|---|---|---|---|---|---|---|
| Time | Control | A | B | C | D | E |
| 0 hours | 17,000 | 21,000 | 14,000 | 11,000 | 19,000 | 21,000 |
| 2 weeks | 3,000,000 | 110 | 22 | 240 | 60 | 11 |
| 3 weeks | — | 0.5 | 0.5 | 0.5 | 0.5 | 0.5 |
| 1 month | — | 0.5 | 0.5 | 0.5 | 0.5 | 0.5 |

TABLE 6
Examination of mold in a beverage composition at 27° C.
Mold results are shown in duplicate as Mold 1 and Mold 2.

| Composition | Mold 1 | Mold 2 |
|---|---|---|
| Control | 3 | 3 |
| A | 0 | 0 |
| B | 0 | 0 |
| C | 0 | 0 |
| D | 0 | 0 |
| E | 0 | 0 |

From data in Tables 5 and 6, beverage compositions of the present invention are prepared using either dry or solution formulations of polylysine falling within the scope of the present invention. Those beverage compositions of the present invention exhibit microbial stability within 14-28 days of being inoculated (for yeasts) in comparison to an unpreserved beverage (control).

### Example 4

A non-carbonated beverage matrix was prepared and evaluated as detailed in Example 1 but with the following preservative systems:

| | Sorbic | | | | | | | |
|---|---|---|---|---|---|---|---|---|
| Beverage | Acid | EDTA | Polylysine | | % DV | | | % |
| Composition | (ppm) | (ppm) | (ppm) | % Juice | Calcium | pH | °Brix | Acid |
| Control | 0 | 0 | 0 | 10 | 10 | 3.83 | 11.7 | 0.29 |
| A | 250 | 30 | 1.5 | 10 | 10 | 3.83 | 11.7 | 0.29 |
| B | 350 | 30 | 1.5 | 10 | 10 | 3.83 | 11.7 | 0.29 |
| C | 400 | 30 | 1.5 | 10 | 10 | 3.83 | 11.7 | 0.29 |

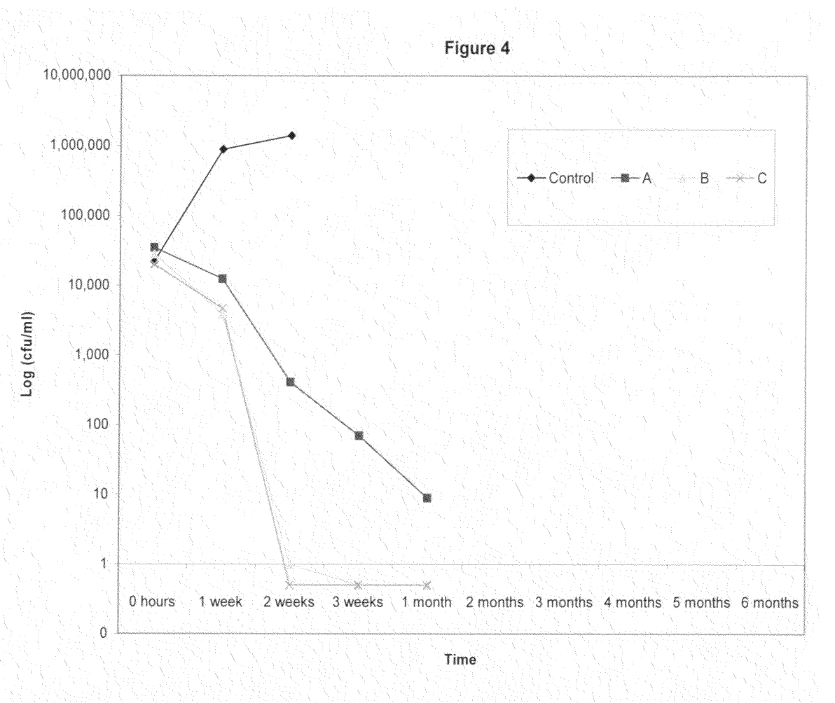

Table 7 summarizes the results of the experiments. FIG. 4 graphically illustrates the results found in Table 7.

TABLE 7
Examination of yeasts (mean CFU/ml) in a beverage composition at
27° C.

Beverage Composition

| Time | Control | A | B | C |
|---|---|---|---|---|
| 0 hours | 22,000 | 35,000 | 28,000 | 20,000 |
| 1 week | 890,000 | 12,500 | 3,900 | 4,700 |
| 2 weeks | 1,400,000 | 410.0 | 1.0 | 0.5 |
| 3 weeks | — | 70.0 | 0.5 | 0.5 |
| 1 month | — | 9.0 | 0.5 | 0.5 |

TABLE 8
Examination of mold in a beverage composition at 27° C.
Mold results are shown in duplicate as Mold 1 and Mold 2.

| Composition | Mold 1 | Mold 2 |
|---|---|---|
| Control | 3 | 3 |
| A | 0 | 0 |
| B | 0 | 0 |
| C | 0 | 0 |

From data in Tables 6 and 7, each beverage was fortified with 10% of the U.S. daily value of calcium. The control and beverage A failed to produce a 2 log reduction in microorganisms, i.e., yeasts, within 14-28 days. However, beverage compositions B and C of the present invention exhibit microbial stability within 14-28 days of being inoculated, when compared to an unpreserved beverage (control).

### Example 5

A non-carbonated beverage matrix was prepared and evaluated as detailed in Example 1 but with the following preservative system:

| | Sorbic | | | | | | |
|---|---|---|---|---|---|---|---|
| Beverage | Acid | EDTA | Polylysine | | | | % |
| Composition | (ppm) | (ppm) | (ppm) | % Juice | pH | °Brix | Acid |
| Control | 0 | 0 | 0 | 10 | 3.49 | 12.26 | 0.28 |
| A | 200 | 30 | 2 | 10 | 3.49 | 12.26 | 0.28 |
| B | 250 | 30 | 2 | 10 | 3.49 | 12.26 | 0.28 |
| C | 350 | 30 | 2 | 10 | 3.49 | 12.26 | 0.28 |

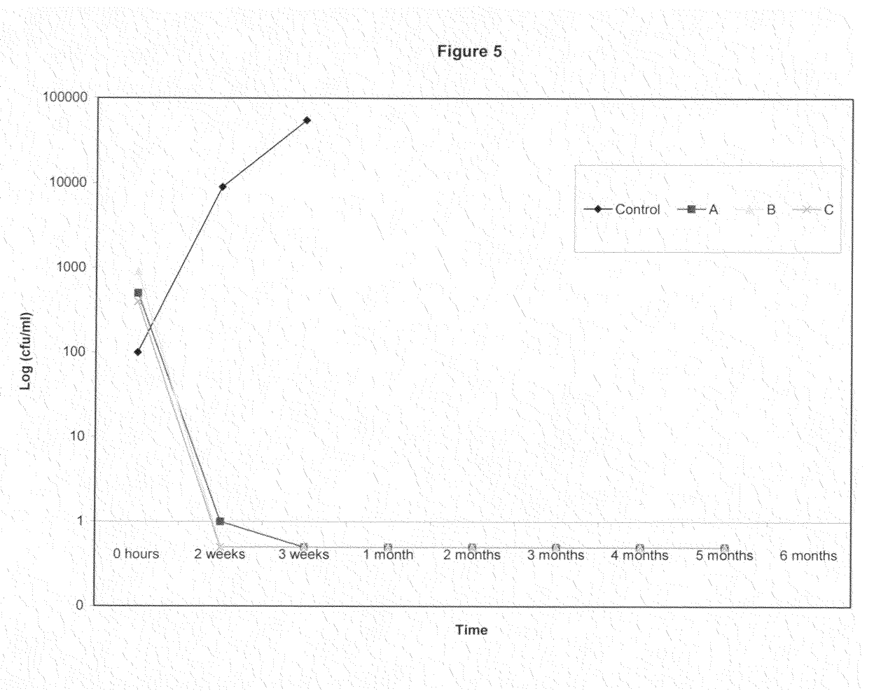

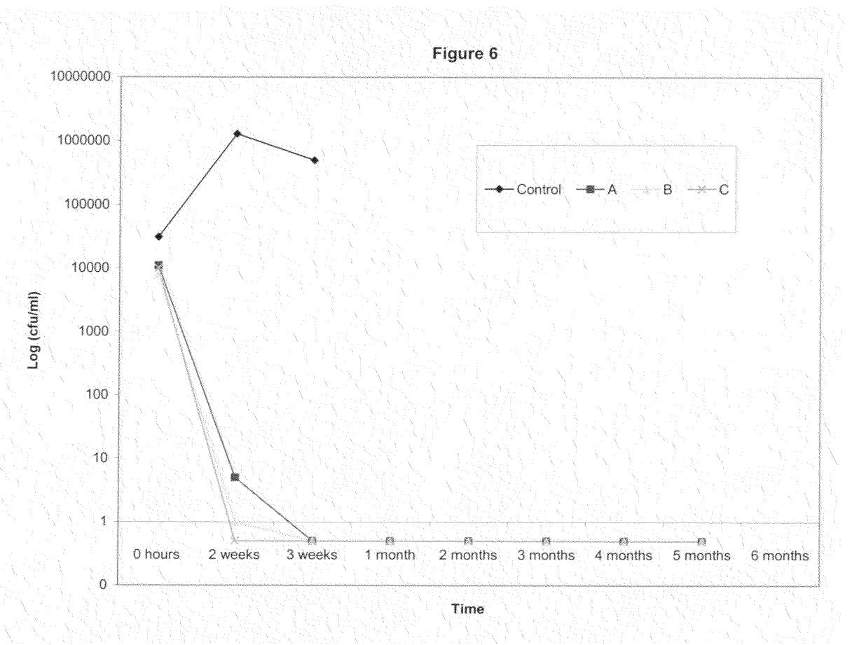

Tables 9 through 11 summarize the results of the experiments. In addition, FIG. 5 graphically illustrates the bacteria results found in Table 9. FIG. 6 graphically illustrates the yeast results found in Table 10.

TABLE 9
Examination of bacteria (mean CFU/ml) in a beverage
composition at 27° C.

Beverage Composition

| Time | Control | A | B | C |
|---|---|---|---|---|
| 0 hours | 100 | 500 | 900 | 400 |
| 2 weeks | 9,000 | 1 | 0.5 | 0.5 |
| 3 weeks | 55,000 | 0.5 | 0.5 | 0.5 |
| 1 month | — | 0.5 | 0.5 | 0.5 |
| 2 months | — | 0.5 | 0.5 | 0.5 |
| 3 months | — | 0.5 | 0.5 | 0.5 |
| 4 months | — | 0.5 | 0.5 | 0.5 |
| 5 months | — | 0.5 | 0.5 | 0.5 |

TABLE 10
Examination of yeasts (mean CFU/ml) in a beverage
composition at 27° C.

Beverage Composition

| Time | Control | A | B | C |
|---|---|---|---|---|
| 0 hours | 31,000 | 11,000 | 8,000 | 10,000 |
| 2 weeks | 1,300,000 | 5.0 | 1.0 | 0.5 |
| 3 weeks | 500,000 | 0.5 | 0.5 | 0.5 |
| 1 month | — | 0.5 | 0.5 | 0.5 |
| 2 months | — | 0.5 | 0.5 | 0.5 |
| 3 months | — | 0.5 | 0.5 | 0.5 |
| 4 months | — | 0.5 | 0.5 | 0.5 |
| 5 months | — | 0.5 | 0.5 | 0.5 |

TABLE 11
Examination of mold in a beverage composition at 27° C.
Mold results are shown in duplicate as Mold 1 and Mold 2.

| Composition | Mold 1 | Mold 2 |
|---|---|---|
| Control | 3 | 3 |
| A | 0 | 0 |
| B | 0 | 0 |
| C | 0 | 0 |

From Tables 9 through 11, beverage compositions A, B, and C exhibited microbial stability with a reduction by 2 logs within 14-28 days when inoculated with bacteria and yeasts. In addition, compositions A, B, and C also demonstrated reduction in mold expression, i.e., zero or no growth.

### Example 6

A non-carbonated beverage matrix was prepared and evaluated as detailed in Example 1 but with the following preservative systems:

| | Sorbic | | Cinnamic | | | | | |
|---|---|---|---|---|---|---|---|---|
| Beverage | Acid | EDTA | Acid | Polylysine | % | | | % |
| Composition | (ppm) | (ppm) | (ppm) | (ppm) | Juice | pH | °Brix | Acid |
| Control | 0 | 0 | 0 | 0 | 10 | 3.45 | 11.72 | 0.28 |
| A | 250 | 30 | 0 | 2 | 10 | 3.45 | 11.72 | 0.28 |
| B | 350 | 30 | 0 | 2 | 10 | 3.45 | 11.72 | 0.28 |

Table 12 summarizes the results of the experiments.

TABLE 12
Examination of Z. bailii (mean CFU/ml) in beverage
compositions at 27° C.

| | Beverage | | |
|---|---|---|---|
| | Composition | | |
| Time | Control | A | B |
| 0 hours | 500.0 | 200.0 | 200.0 |
| 2 weeks | 180.0 | 0.5 | 0.5 |
| 3 weeks | 350.0 | 0.5 | 0.5 |
| 1 month | — | 0.5 | 0.5 |
| 2 months | — | 0.5 | 0.5 |
| 3 months | — | 0.5 | 0.5 |
| 4 months | — | 0.5 | 0.5 |
| 5 months | — | 0.5 | — |
| 6 months | — | 0.5 | 0.5 |

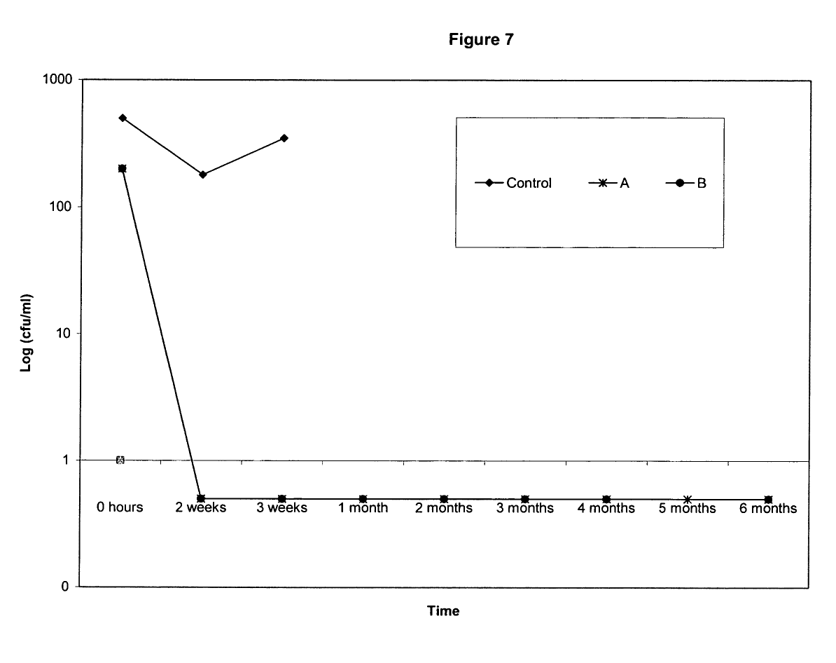

From data in Table 12, the present invention has the ability to provide bacteriocidal capability when about 2 ppm of polylysine is incorporated in a beverage composition. The results from Table 12 are graphically illustrated in FIG. 7.

What is claimed is:

1. A beverage composition comprising:
a preservative system comprising from about 0.1 ppm to about 150 ppm of polylysine and from about 10 ppm to about 1000 ppm of at least one weak acid chosen from cinnamic acid, benzoic acid, sorbic acid, alkali metal salts thereof, and mixtures thereof; and
at least one beverage component, wherein the beverage composition has a pH ranging from about 1.5 to about 4.5.

2. The composition according to claim 1, wherein the at least one beverage component is chosen from at least one juice, at least one sweetener, and mixtures thereof.

3. The composition according to claim 1, wherein the polylysine is present in an amount ranging from about 0.75 ppm to about 20 ppm.

4. The composition according to claim 3, wherein the polylysine is present in an amount ranging from about 0.75 ppm to about 10 ppm.

5. The composition according to claim 4, wherein the polylysine is present in a range from about 0.75 ppm to about 2 ppm.

6. The composition according to claim 1, wherein the at least one weak acid is present in an amount ranging from about 10 ppm to about 500 ppm.

7. The composition according to claim 6, wherein the at least one weak acid is present in an amount ranging from about 100 ppm to about 500 ppm.

8. The composition according to claim 7, wherein the at least one weak acid is present in an amount ranging from about 150 ppm to about 350 ppm.

9. The composition according to claim 1, wherein a single weak acid is cinnamic, benzoic, sorbic acid, or alkali metal salts thereof, wherein the single weak acid is present in an amount ranging from about 10 ppm to about 500 ppm.

10. The composition according to claim 1, wherein the at least one weak acid is sorbic acid.

11. The composition according to claim 10, wherein the sorbic acid is present in a range from about 150 ppm to about 350 ppm.

12. The composition according to claim 1, further comprising from about 60% to about 99% of water by volume relative to the total composition.

13. The composition according to claim 12, wherein the water is present in an amount ranging from about 80% to about 99% by volume relative to the total composition.

14. The composition according to claim 12, wherein the water has a hardness value ranging from about 55 ppm to about 250 ppm.

15. The composition according to claim 14, wherein the water has a hardness value ranging from about 60 ppm to about 180 ppm.

16. The composition according to claim 2, wherein the at least one beverage component is at least one juice.

17. The composition according to claim 16, wherein the at least one juice is present in an amount ranging from about 0.1% to about 100% by volume relative to the total composition.

18. The composition according to claim 17, wherein the at least one juice is present in an amount ranging from about 0.5% to about 25% by volume relative to the total weight of the composition.

19. The composition according to claim 16, wherein the at least one juice is chosen from juices of fruits, vegetables, botanicals, and mixtures thereof.

20. The composition according to claim 19, wherein the at least one juice comprises fruit juice.

21. The composition according to claim 19, wherein the at least one juice comprises vegetable juice.

22. The composition according to claim 2, wherein the at least one beverage component is at least one sweetener.

23. The composition according to claim 22, wherein the at least one sweetener is chosen from nutritive sweeteners, non-nutritive sweeteners, and mixtures thereof.

24. The composition according to claim 2, wherein the at least one beverage component comprises at least one juice and at least one sweetener.

25. The composition according to claim 1, further comprising from about 10 ppm to about 40 ppm of EDTA.

26. The composition according to claim 25, wherein the EDTA is present in a range from about 10 ppm to about 30 ppm.

27. The composition according to claim 26, wherein the EDTA is present in a range from about 15 ppm to about 25 ppm.

28. The composition according to claim 1, further comprising at least one additional ingredient chosen from preservatives, coloring agents, flavoring agents, flavonoids, vitamins, minerals, proteins, emulsifiers, carbonation components, thickeners, antioxidants, anti-foaming agents, and mixtures thereof.

29. A beverage composition comprising:
a preservative system comprising from about 0.1 ppm to about 150 ppm of polylysine, from about 10 ppm to about 40 ppm EDTA, and from about 10 ppm to about 1000 ppm of at least one weak acid chosen from cinnamic acid, benzoic acid, sorbic acid, alkali metal salts thereof, and mixtures thereof; and
at least one beverage component, wherein the beverage composition has a pH ranging from about 1.5 to about 4.5.
